(19) United States
(12) Patent Application Publication
(10) Pub. No.: US 2012/0212955 A1
(43) Pub. Date: Aug. 23, 2012

(54) Light Having an Optical Element with Two States and Method for Operating the Light

(76) Inventor: Markus SALM, Heusweiler (DE)

(21) Appl. No.: 13/396,175

(22) Filed: Feb. 14, 2012

Related U.S. Application Data
(60) Provisional application No. 61/442,618, filed on Feb. 14, 2011.

(30) Foreign Application Priority Data
Feb. 14, 2011 (DE) 10 2011 004047.1

(51) Int. Cl. F21V 9/08; F21V 21/14

(52) U.S. Cl. 362/231

(57) ABSTRACT

A light includes a multicolor LED source for example comprising rgb LEDs. Further, a white light source in the form of a white LED is provided arranged separately from the multicolor LED source. Further, an optical element is provided which is implemented to be capable of being brought into two different states, wherein in a first state the output of the multicolor LED source forms a light beam output by a projection optics while when the optical element is in the second state the output light beam is mainly formed by the light beam generated by the white light source.

### CROSS-REFERENCE TO RELATED APPLICATIONS

This application claims priority from German Patent Application No. 102011004047.1, filed on Feb. 14, 2011, and U.S. Patent Application No. 61/442,618 filed 14 Feb. 2011, both of which are incorporated herein in their entirety by reference.

### BACKGROUND OF THE INVENTION

The present invention relates to lights and in particular to lights which may be used as spotlights or searchlights in show illumination applications.

With lights there is the need to reproduce the complete visible optical spectrum with a highest possible efficiency by means of a light source or light. One problem here is, that white light is a mixture of different wavelengths and LEDs as illuminants or gas discharge lamps only emit a narrow-banded wavelength range. In standard technology, different approaches exist to solve these problems. One approach is to provide so-called white light LEDs. Such white light LEDs generally are a blue-emitting LED coated with a yellow conversion phosphorous. The light emitted by this combination thus contains blue and yellow components and generates the impression of quasi-white light for the human eye. A spectrum of such a white light LED is illustrated in FIG. 10. It may be gathered from FIG. 10, that this spectrum has no flat course. Instead, this spectrum has a deep well at approximately 490 nm (Cyan) and strongly decreases in the direction of 600 nm (red).

A further approach of standard technology is a so called color combiner. This is a system of several dichroic filters using which the light of several LEDs of different colors may be combined into a common light beam. Generally, a red emitting LED, a green emitting LED and a blue emitting LED are used. Further, this spectrum is divided into an upper, a middle and a lower band. Filters for such light sources are for example available under the trademark of LED Color Dichroics by the company Optics Balzars AG. For the implementation of the color combination different setups exist which are different regarding spatial requirement. Further, coupling stages or input stages may be provided to, for example, further couple in cyan or amber. Such light sources are manufactured as so called LED engines under the trademark of Zorolight by the company of Bookham, which may then be the light sources of complete (to plug) lights. These systems may emit a color-rich spectrum. The precision requirement regarding the assembly of the components and the special dichroic filters make these systems expensive, however. Apart from that, the efficiency is rather low due to the high number of used glass surfaces. Thus, the system has only become established as a special light source in laboratory applications so far. Coupling in white light LEDs is not possible here, as these white light LEDs emit two different peak wavelengths and thus no coupling in by means of dichroic filters may take place. The spectrum of such a light source is illustrated in FIG. 9. A blue peak 90, a green peak 91 and a red peak 92 may clearly be seen. This light source uses the trick that the human eye performs a type of averaging and gives the brain for example the impression of yellow when only the receptors for green and red are addressed.

Thus, also the white light LED may cause no cyan impression for the observer as the yellow and blue portions may not be controlled regarding intensity independent of each other. When filtering out by means of a dichroic color filter, this spectral range would simply be missing.

Further approaches consist in the use of mixer stages which may combine any wavelengths. Such systems are for example set up with the help of light pipes or so called “fly's eye arrays”. Such mixed optics are, compared to the actual LED, very large and thus not suitable for compact systems. Apart from that, due to the internal losses, like for example multiple reflections in the light pipe or cross talk between the lenses with the fly's eye, the efficiency is rather low. It may thus be case that it is desired to mix a white light source with an rgb light source by a light pipe in order to achieve a higher white brightness. Thanks to this low efficiency, only a negligible increase of brightness results with a simultaneously higher energy requirement. This solution may at most improve color saturation but not brightness. Further, due to the size and the secondary effects which may not completely be prevented, this variant is practically only interesting for building so called wash lights.

The advantages of white light LEDs consist of an enormous brightness in the spectral range perceived as white by a human eye. Further, here improvements are to be expected, as this is the LED type which is most interesting for the general market of illuminance. Most research is done here and accordingly it is optimized the most. Monochrome red, green and blue LEDs are products with rather small quantities, which is why investments in basic chip research often may not be justified by the manufacturers.

It is the disadvantage of white light LEDs that a fixed white light point exist. The light color of the LED source is determined by the chip materials and may not be set as such. When filtering out certain wavelengths by dichroic color filters, a low efficiency results. In the red range a phosphor-converted LED only has a very low emission. A dichroic color filter for saturated red shows a transmission of approximately 2-2.5%. The brightness which may thus be achieved is partially very low in the range of saturated colors. Apart from that, filters are usually optimized for full-spectrum light sources or gas discharge lamps. Using these filters, with LEDs a rather strange color impression results. Filters optimized to LED wavelengths are custom made and accordingly expensive.

The color combiner lights have the advantage that they are completely tunable light sources. By changing the relative brightness of the individual LEDs, within certain limits also intermediate colors may be mixed. For generating these intermediate colors no dichroic color filters are needed but the mixing of intermediate colors may be done by a different individual control of the individual LED circuits or LED chips. Apart from that, the brightness that may be achieved is very high for saturated colors, as no wavelengths have to be filtered out of the light beam.

It is a disadvantage of color combiner lights, however, that the light flux as a white light source, i.e. when all LEDs are switched on, is substantially less than the light flux of a standard white light LED.

### SUMMARY

According to an embodiment, a light may have a multicolor LED source for emitting a first light beam in a first direction; a white light source arranged and implemented separately from the multicolor LED source in order to emit a second light beam in a second direction; a projection optics for outputting an output light beam of the light; and an optical element which is implemented to be capable of being brought into at least two different states so that in a first state the output light beam is mainly formed by the first light beam and that in a second state the output light beam is mainly formed by the second light beam.

According to another embodiment, a method for operating a light having a multicolor LED source for emitting a first light beam in a first direction, a white light source arranged separately from the multicolor LED source and implemented to emit a second light beam in a second direction; a projection optics for outputting the output light beam of the light and an optical element which is implemented to be capable of being brought into at least two different states may have the steps of bringing the optical element into the first state so that the output light beam is mainly formed by the first light beam; and bringing the optical element into the second state so that the output light beam is mainly formed by the second light beam.

The present invention is based on the finding that a combination of a multicolor LED source and a white light source individually adapted to the same combines the advantages of the approaches of standard technology, but prevents the disadvantages of the approaches of standard technology. According to the invention, a multicolor LED source for emitting a first light beam in a first direction is provided. Apart from that, a white light source separately arranged from the multicolor LED source is provided in order to emit a second light beam in a second, different direction. The light further includes projection optics for outputting an output light beam of the light and an optical element which is implemented to be capable of being brought into at least two different states, wherein the states are such that in a first state the output light beam is formed substantially by the first light beam and that in a second state the output light beam is substantially formed by the second light beam. In certain implementations the optical element may be a movable optical element comprising a mirror or a dichroic filter. In other embodiments, the optical element may be an electronically or otherwise controllable element which is transparent or non-transparent depending on the control signal.

It is one advantage of the present invention that when colored light is needed, the multicolor LED source forms the main part of the output light beam with a corresponding position of the optical element. Thus, any desired color may be set with good color intensity. If, however, white light is desired, the white light source, which is especially implemented for a high emission of white light, is so to speak “connected through” to the output using the optical elements, so that its output light beam also mainly forms the output light beam of the light.

This switchability is advantageous in so far as it turned out that in the market of show illuminance there is mainly the case of application of white light or the case of application of colored light.

The case of application in which slightly colored white light is needed is, for example, interesting for theater applications. Here, however, usually no high brightnesses are needed. Thus, this case of application may typically be covered by the multicolor LED source alone by bringing the optical element into the state in which the output light beam is mainly or exclusively determined by the multicolor LED source.

For other applications in which both intensive colors and also bright white light are needed, depending on the application, either the multicolor LED source or the white light source is “connected through” to the projection optics using the corresponding control of the optical element.

In one embodiment, as a multicolor LED source an rgb slight source is used which is advantageously set up with the help of a dichroic color combiner. In this implementation, a phosphor-converted white light LED is used as a white light source. Alternative white light sources also include gas discharge lamps or similar non-LED-based sources, although LED-based sources provide special advantages with certain embodiments.

In one embodiment, a movable optical element is used as the optical element which comprises a wing mirror or tilting mirror similar to a reflex camera and thus may achieve a selection between the multicolor LED source and the white light source.

### BRIEF DESCRIPTION OF THE DRAWINGS

In the following, embodiments of the present invention are explained in more detail with reference to the accompanying drawings, in which:

FIG. 1 is a block diagram of the light according to one embodiment of the present invention;

FIG. 2 is an alternative implementation of the inventive light;

FIG. 3 is a view of the implementation of the light of FIG. 2 wherein the optical element is in a different state;

FIG. 4 is an alternative implementation of the light according to the present invention having a rotatable optical element;

FIG. 5 is an alternative embodiment of the light according to the present invention having a two-piece rotatable optical element;

FIG. 6 is a top view onto two different mirrors for being used in the embodiments of FIG. 4 and FIG. 5;

FIG. 7 is an illustration of different relative positions of two mirrors for the light according to the embodiment of FIG. 5;

FIG. 8 is a time diagram for illustrating the synchronization between the PWM signal and the rotation of the optical element according to the embodiment of FIG. 4 or FIG. 5;

FIG. 9 is a relative spectral power distribution for a multicolor LED source having a red emitting LED, a green emitting LED and a blue emitting LED;

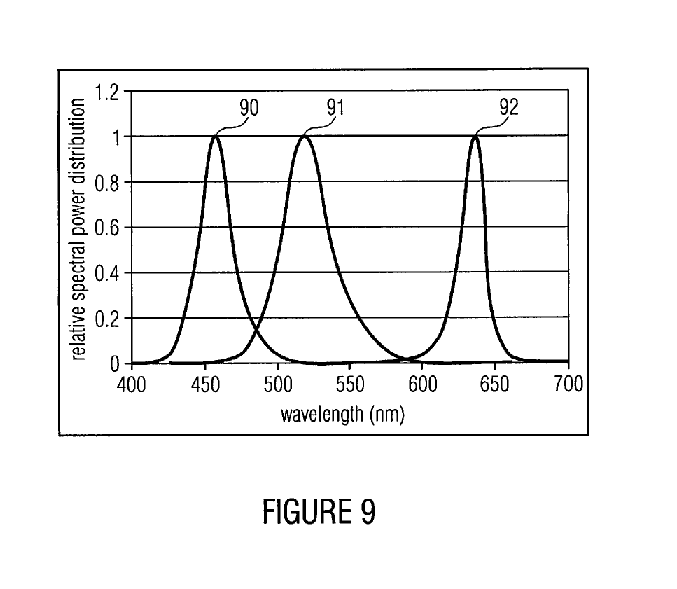

FIG. 10 is an illustration of a spectrum for a white light source having an LED and a conversion layer; and

FIG. 11 is an overlaying of a spectrum of a multicolor LED source and a spectrum of a white light source.

### DETAILED DESCRIPTION OF THE INVENTION

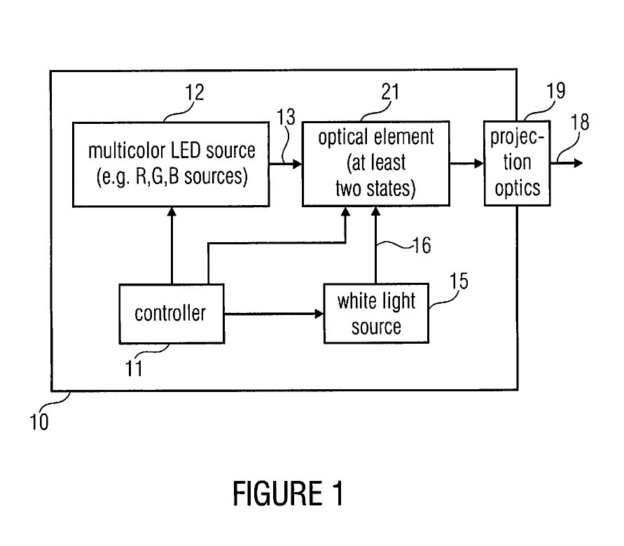

FIG. 1 shows a light which is accommodated in a housing 10. As it is schematically illustrated in FIG. 1, the light includes a multicolor LED source 12 for emitting a first light beam 13 in a first direction. Further, a white light source 15 is arranged and implemented separately from the multicolor LED source to emit a second light beam 16 in a second direction. As it is illustrated in FIG. 1, the first direction 13 is orthogonal to the second direction 16. Also other implementations exist, however, in which the directions 13 and 16 are not orthogonal but are at an angle with respect to each other. This is advantageous, although also sources may be used which emit in the same direction in order to finally generate the output light beam of the light designated by reference numeral 18, which is in particular output by projection optics 19. Apart from that, the light includes an optical element 21 which is implemented to be brought into at least two different states. The states are in particular so that in a first state the output light beam 18 is mainly formed by the first light beam 13 and that in a second state of the optical elements 21 which is different from the first state of the optical element 21 the output light beam 18 is mainly formed by the second light beam 16. In certain implementations, as it is explained in the following, the output light beam is then, when the optical element is in the first state, exclusively formed by the output light beam of the multicolor LED source 12, and when the optical element 21 is in the second state the output light beam 18 is exclusively formed by the white light source 15. In such a case, the optical element is implemented to substantially let the light beam 13 of the multicolor LED source pass completely in the first state, while in the second state the light beam 13 of the multicolor LED source is completely absorbed or reflected and the optical element is implemented to reflect the output light beam 16 of the white light source 15 completely or partially towards the projection optics 19. It is thus advantageous that one of the two sources is arranged such that the direction of the light beam output by one of those two sources “hits” the projection optics 19. Alternatively, however, both sources may also be arranged so that the directions of both output light beams do not hit or impinge upon the projection optics that, however, depending on the state of the optical element one of the two light beams is directed towards the projection optics while the other one of the two light beams is not directed towards the projection optics. Depending on the implementation, also both sources may be arranged such that their output light beams without the optical element “impinge upon” the projection optics. In such a case the optical element is effective to substantially cover the first beam in its first state and let the second beam pass, or vice versa.

Depending on the implementation, the optical element is a mechanically operable element, an electrically operable element, an electro-mechanically operable element, a magnetically operable element or any differently operable element which may be brought into two different states and which is arranged with respect to the LED sources so that depending on the state, the output light beam is formed mainly by the first light beam of the multicolor LED source or by the second light beam of the white light source. The output light beams of the two sources 12, 15 do not have to be collimated beams or the like. In this context, the output light beams only designate a light output from any type of different sources.

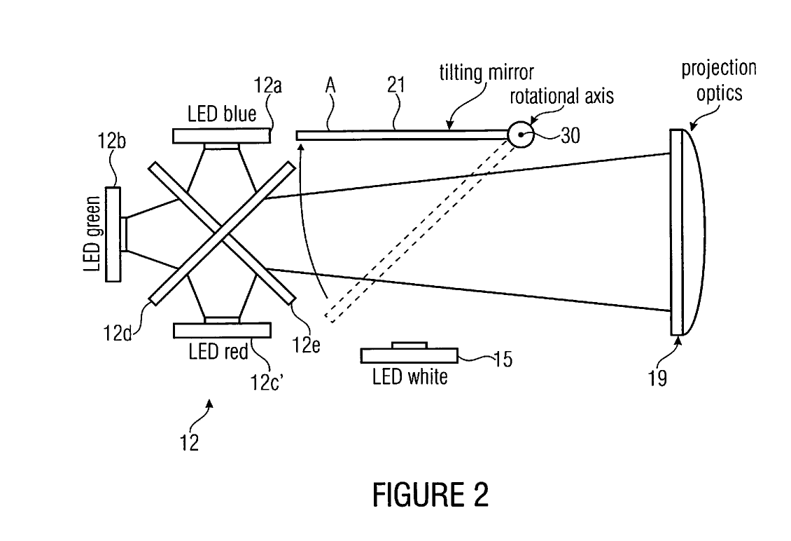

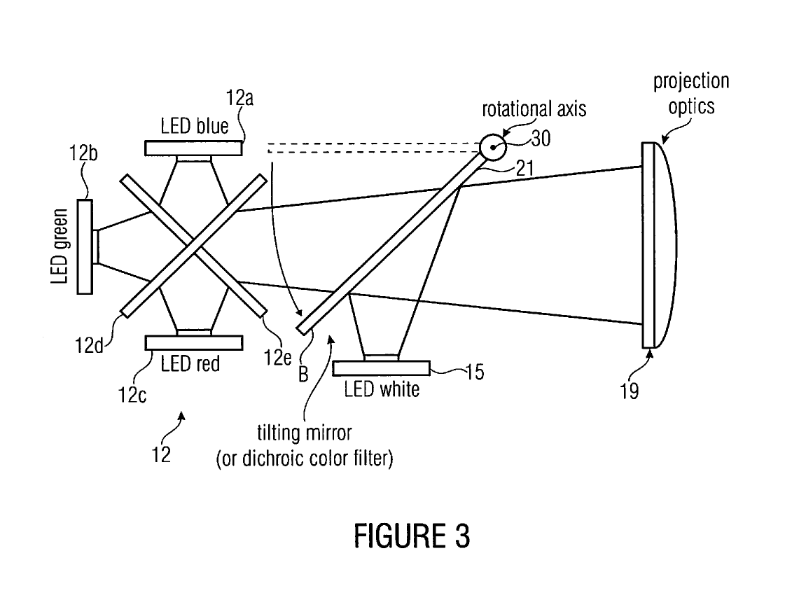

FIG. 2 shows an embodiment of the present invention in which the white light source is a white LED. Apart from that, the multicolor LED source 12 is implemented in a compact implementation insofar that it comprises a blue emitting 12a, a green emitting LED 12b, a red emitting LED 12c, a first filter element 12d and a second filter element 12e. In particular, both filter elements 12d and 12e are implemented to allow the light output of the green LED 12b. Further, the element 12d is implemented not to let the light output of the blue LED pass, but to reflect the same in the direction of the projection optics 19. In contrast, the element 12d for blue light is transparent. Accordingly, the element 12d for red light is reflecting and the element 12e is transparent for red light. The tilting mirror 21 is attached to an axis of rotation 30 and represents the optical element. In this case, the optical element is a movable optical element and the two states are different mechanical positions of the tilting mirror 21. Thus, FIG. 2 shows a first position A while FIG. 3 shows a second position B. In the first position A in FIG. 2 the output light beam of the multicolor LED source 12 is directed to the projection optics 19 and the optical element 21 is folded or tilted out of the optical path. However, in the embodiment illustrated in FIG. 3, the optical element 21 is folded into the optical path, wherein the optical element 21 is advantageously implemented as a mirror, wherein the coated mirroring surface is attached to the side of the optical elements 21 onto which the light of the white LED 15 is falling. By this, the light of the white LED, i.e. the second light beam, is reflected by the mirror 21 and directed onto the projection optics 19 in order to form the output light beam. The light of the LEDs 12a, 12b, 12c is either absorbed by the mirror 21, however, or reflected upwards, i.e. not into the projection optics. In one position of the mirror 21 of FIG. 3, the multicolor LED source 12 may also be switched off in some implementations. Likewise, when the mirror is in the position of FIG. 2, the white light source 15 may be switched off.

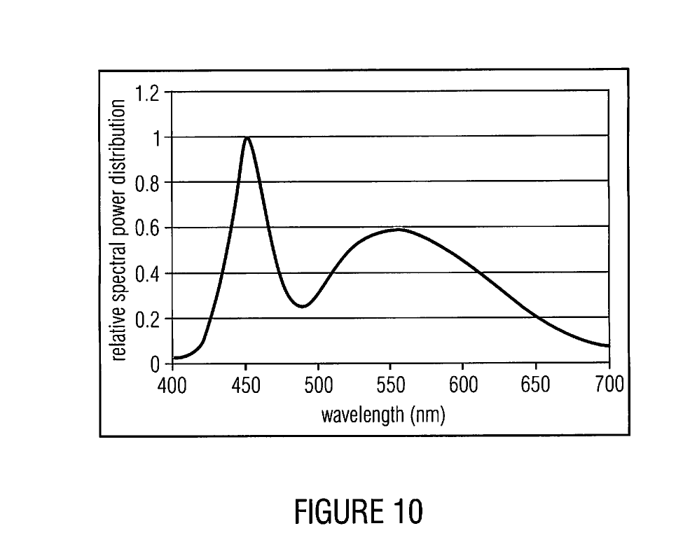

In particular in the embodiments illustrated in FIGS. 2 and 3, one of the two light sources is positioned so that it may directly irradiate into the imaging optics of the spotlight. The second light source or optics is mounted twisted by 90° with respect to the same. The tilting mirror is in its rest position as it is illustrated in FIG. 2, in which the light source 1 is active, next to the optical path. If, however, the light source 2 is activated, the mirror tilts by 45° into the optical path and redirects the light beam from the light source 2 so that the same may now irradiate into the imaging optics or projection optics 19. It is thus advantageous to mount the multicolor LED source such that the same directly forms the output light beam when the optical element is in its first state as the brightness of the white light source is typically greater than the brightness of the LED source, so that the white light source may deal with reflection losses at the mirror 21 better than the rgb source. The reason for this is that the mirror has an efficiency smaller than 1. In the implementation, however, also building size considerations may determine the positioning of the two sources with respect to the projection optics. In one alternative embodiment, the mirror 21 is replaced by a dichroic color filter. Thus, for example, the LED light source directly irradiates into the imaging optics while the white light source 15 is arranged twisted by 90°. If now instead of the mirror a dichroic color filter with an edge steepness as high as possible is used, which for example reflects wavelengths below 260 nm and lets the red portion pass, then the output light beam represents a mix of the output light beam of the white LED and the output light beam of the multicolor LED source 12. As the white light source hardly emits in the red range anyway, as it may be gathered from FIG. 10, the loss due to the dichroic filter, which does not reflect the red portion to the projection optics 19 but so to speak lets it pass upwards, is not as high. Apart from that, this red loss may not only be compensated by admixing red from the rgb light source, but may also be set in a controlled way. By admixing even more red from the rgb source, in the embodiment illustrated in FIG. 3 the color temperature of the white light beam may be set in wide limits.

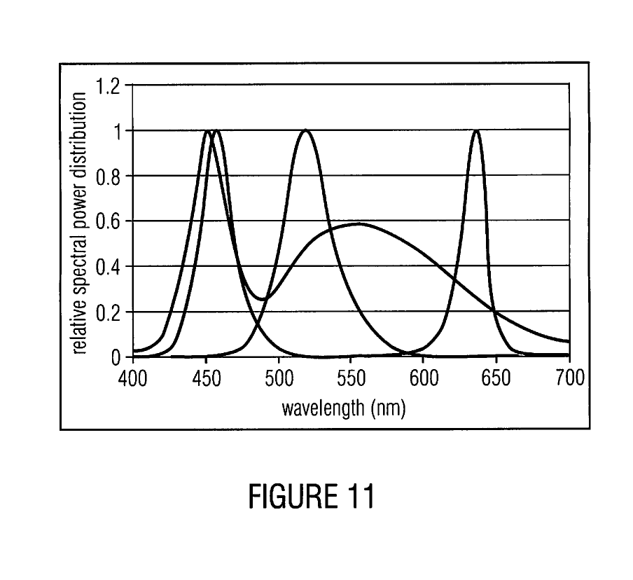

Thus, FIG. 11 shows an overlaying of the spectral curves of the rgb light source and the white light source for clarity. When the same are combined by means of dichroic color filters, the light portions beyond the color filter threshold would be canceled which is not considered in FIG. 11, however.

Advantageously, in this embodiment the white light source ought to have a color temperature as high as possible, i.e. a blue portion as high as possible. Setting low color temperatures may then be done by admixing red from the rgb source via the optical element 21. This has a further advantage. With white LEDs lower color temperatures are mainly achieved by thicker layers of conversion phosphor. The same also have a lower efficiency, however, and convert the irradiated blue light into heat to a large extent. White phosphor converted LEDs with a high color temperature are thus usually brighter than those having lower color temperatures. Such a white light LED with a high color temperature may be replaced by the arrangement illustrated in FIG. 3 to also provide a white light LED with a lower color temperature. In this case, only the red LED would be active and the two other LEDs 12a, 12b would be deactivated. The red portion in the output light beam may be controlled by the control signal for the red LED 12c, i.e. by varying the PWM ratio. The light output of the red LED 12c is increased by increasing the PWM pulse per PWM clock in order to admix more red, while when less red is to be admixed, the time duration of the PWM impulse per PWM clock is reduced.

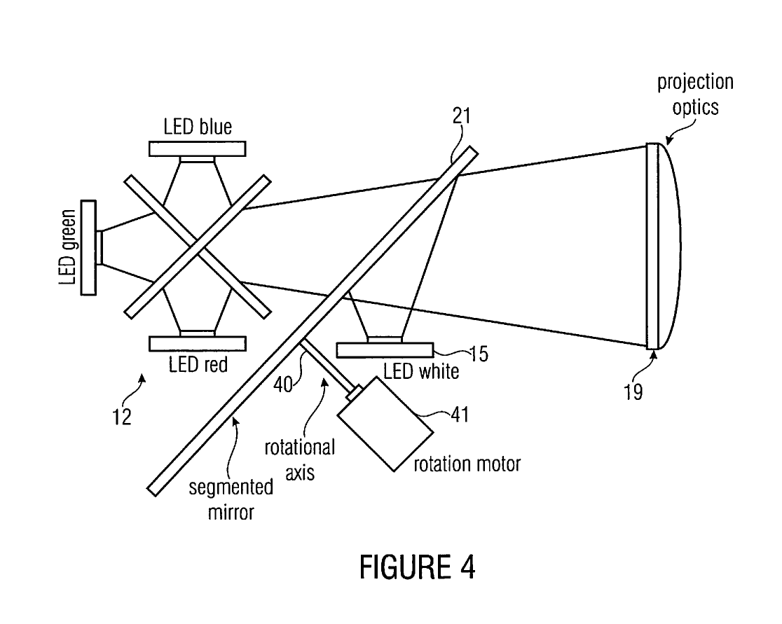

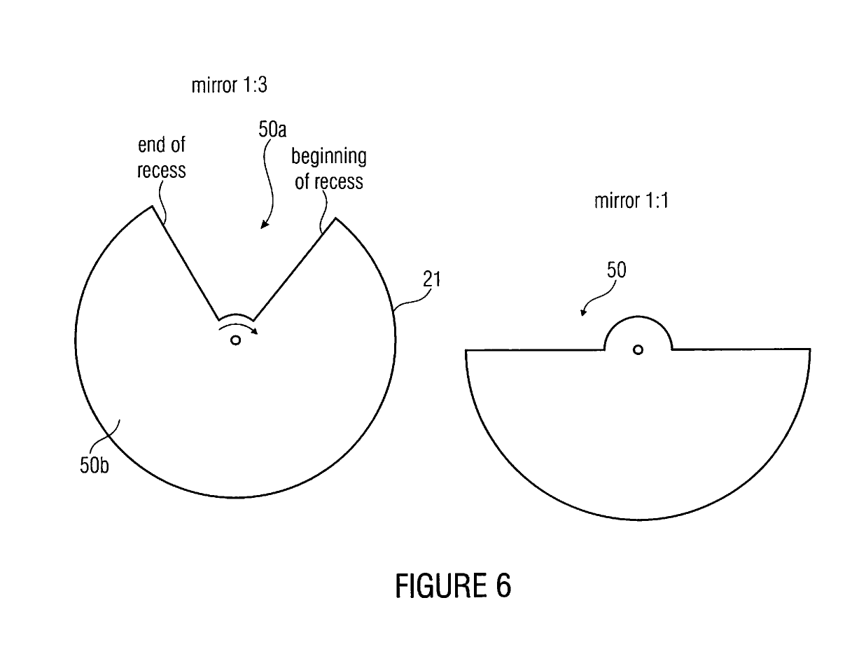

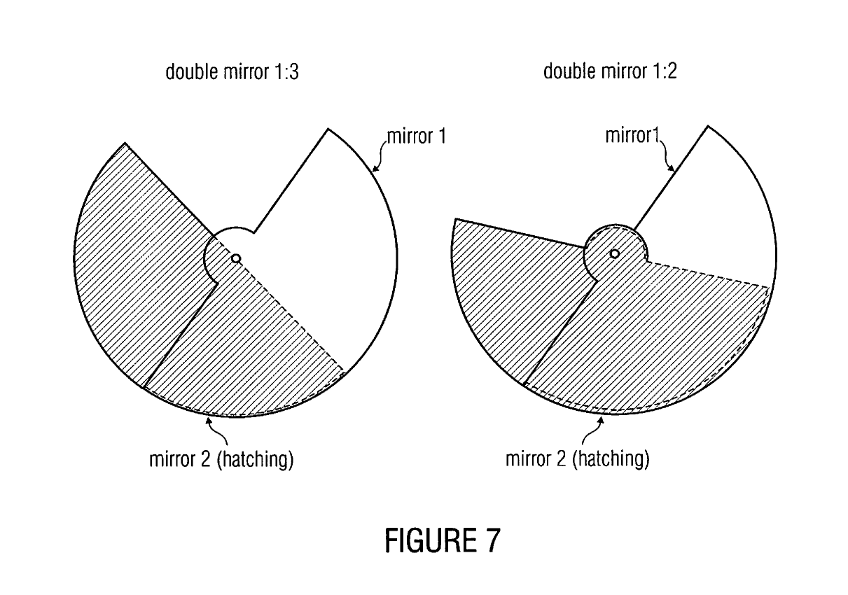

In certain applications, the embodiment illustrated in FIG. 3 has a disadvantage insofar as both light sources of the mirror ought to be switched off during the tilting process. Otherwise, wiping effects would be generated regarding the output light beam which would leave the device as scattered light through the projection optics to a certain extent. In order to eliminate this disadvantage, in the embodiment illustrated in FIG. 4 a tilting mirror (in contrast to the wing mirror in FIG. 2 and FIG. 3) is provided as an optical element. In the embodiment of the tilting mirror, the optical element is a rotatable wheel comprising areas of different characteristics, as it is illustrated with reference to FIGS. 6 and 7. The segmented wheel is mounted to a motor axis or engine axis 40 and is arranged twisted by 45° with respect to the two light sources 12 and 15 which is similar to the rgb color wheels for color channel selection with video projectors. This rotational axis 40 is driven by a rotation motor 41 which may thus set the optical element in the form of a rotatable wheel 21 in rotation. As it is illustrated in FIG. 6, the wheel 21 may have one or several recesses 50 through which the light beam of the multicolor LED source 12 may irradiate into the imaging optics 19. If the wheel is rotated further, the light beam of light source 2 falls onto the part of the wheel at which the recess is not arranged and is redirected into the imaging optics. The advantage of this variant is that there is no wiping or blurring effect in the tilting process. In one implementation, this mirror 21 may be replaced by a suitable dichroic color filter as it was indicated in connection with FIG. 3. The wheel 21 thus comprises a first area with a first characteristic in which no recess exists and an area with a second characteristic in which the recess exists. In this implementation, however, the areas of a different characteristic do not have to be implemented by the existence of material on the one hand and a non-existence of material on the other hand. Instead, the recessed area may also be an area which is transparent for the radiation of a light source and reflecting for the radiation of a different light source, while the other area which corresponds to the non-recessed area in FIG. 6 is such that here the reflection/transmission characteristics are reversed.

If the two light sources are not arranged 90° with respect to each other, depending on the reflection direction, the alignment of the wheel 21 would be in a different angle to 45°.

A substantial advantage of the implementation of FIG. 4 is that now a color mixing may be executed in a temporally controlled way. Thus, by a corresponding positioning of the color wheel, i.e. the optical element, the one or the other light source each may be selected permanently. This means, that by the motor 41 the wheel is only rotated across a certain angle smaller than 360° in order to either position the recess in the optical path or position the same out of the optical path. Then, after the recess has been positioned at the correct location, the motor is stopped again and the rotatable element 21 now remains stationary with respect to the other elements of the light.

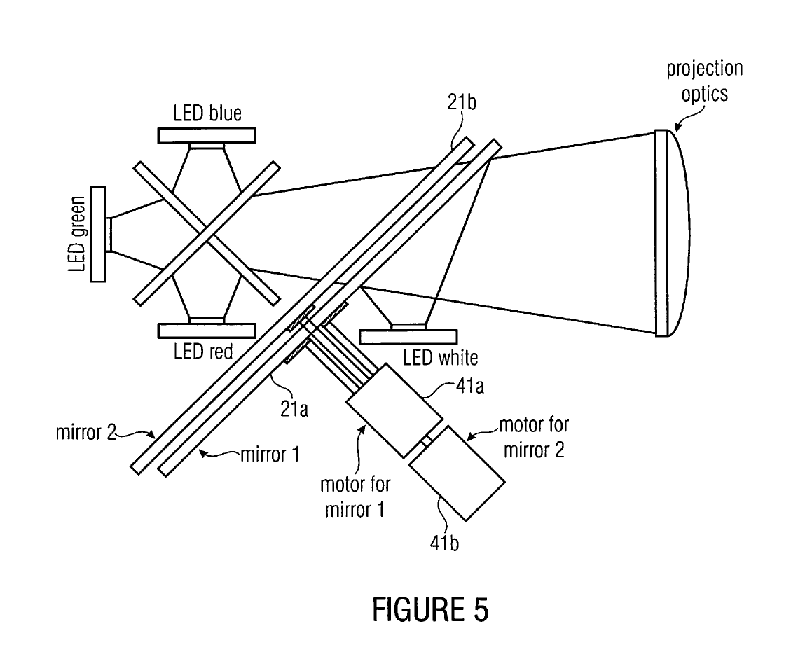

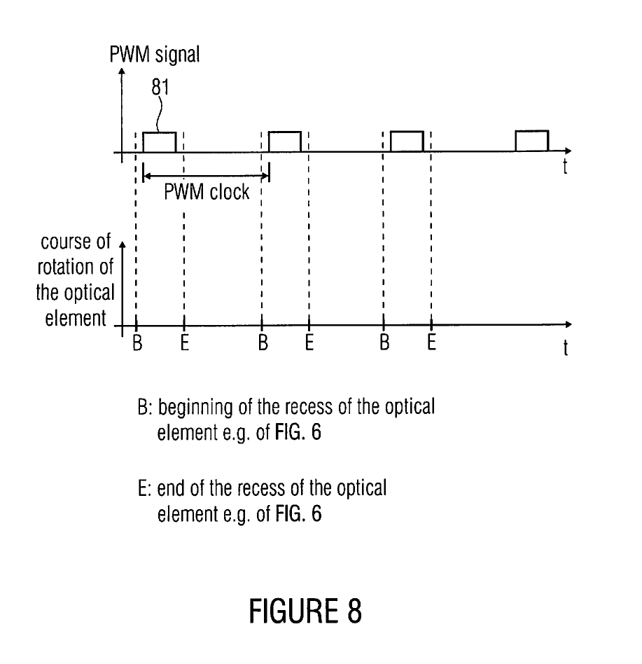

In another implementation the mirror may also rotate as it will be explained with reference to FIGS. 5, 7 and 8. The wheel is thus set into a fast constant rotation, whereby the portions of the light sources of the useful light beam, i.e. the output light beam 19, are mixed in a ratio gap/mirror. In this respect it is advantageous to synchronize the PWM signal of the respective light sources with the rotation as it is schematically illustrated in FIG. 8.

In the upper area FIG. 8 shows a typical course of a PWM signal with a PWM clock and a PWM impulse 81 which repeats from clock to clock which means that in the four clocks illustrated in FIG. 8 the light strength of the controlled LED is not changed as the PWM impulses 81 are all of the same length. The second time course in FIG. 8 represents the rotation of the movable element, wherein B stands for the beginning of the recess for example in FIG. 6, while E stands for the end of the recess. Thus, at the time designated by B, the beginning of the recess passes into the area of the optical path in front of the projection optics in which the multicolor LED source irradiates in the embodiment illustrated in FIG. 3. This means that the mirror begins to unblock the area. It is advantageous that then after this time first the PWM signal, i.e. the PWM impulse 81, starts and that the PWM impulse 81 ends before the end of the recess passes the optical path. It is thus guaranteed that beats between the rotational clock and the PWM clock, which may also occur when integer multiples exist between the two frequencies, are suppressed as far as possible. Thus, blinking and flickering effects are prevented which may otherwise occur.

It is to be noted that the multicolor LED source, in particular when it is implemented as an rgb light source, may well fulfill all applications for saturated colors and that white light applications are rather a discrete admixing of colors. For this reason it is advantageous not to use a symmetrical distribution of the mirror segments on the wheel as it is illustrated on the right side of FIG. 6, but an area distribution in favor of one of the light sources. In one variant of 1:10 (rgb: white), accordingly a white light beam with an intensity of a maximum of 90% of the white light source and a maximum of 10% of admixed color from the rgb light source may be achieved. An alternative distribution is illustrated in FIG. 6, where ¼ is represented as a recess and ¾ of the circle as a mirror surface. In order to control the angular range or the area of the recesses, it is advantageous to use the embodiment illustrated in FIGS. 5 and 7. Here, the rotation motor uses two individual motors 41a, 41b, wherein the motor 41a is implemented for the mirror 1 21a and the motor 41b is implemented for the mirror 2 21b. Mirror 1 and mirror 2 are basically parallel and arranged relatively close to each other and may be twisted with respect to each other by operating the individual motors 41a, 41b. Together, the individual motors 41a and 41b thus form a coaxial stepper motor as a drive for two mirror wheels which are positioned closely one after another and may each cover a mirror surface corresponding to a sector of 180°.

If both mirror wheels are set into a rotation in the same direction and of the same speed in a state in which they are fixed relative to each other, by setting the angles with respect to each other, the mirror area or surface ratio may be set between 50% and 100% in order to thus further vary the respective color admixing factor as it may be gathered from the plot of FIG. 7. In one implementation, however, also for the multicolor LED source LEDs of different wavelengths may be used, like for example cyan, amber, UV, IR, LEDs with remote phosphor, etc. Further, the “interfaces” of the dichroic filters may also be set into a different wavelength range.

Apart from this it is to be noted not only red may be admixed to the white light source but also any other color depending on the control of the individual LEDs 12a, 12b, 12c. If red is to be admixed, LEDs 12a, 12b are deactivated and LED 12c would be active. If, however, other colors apart from red are to be admixed, like for example green, only the LED 12b would be active and the LEDs 12a, 12c would be inactive. If, e.g., blue is to be admixed, only the LED 12a would be active and the LEDs 12b, 12c would be deactivated. For admixing any other mixing or mixed colors in the color space, which may be generated by the LEDs 12a, 12b, 12c, the three LEDs would have to be controlled in a corresponding requested relation or ratio.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A light, comprising:
a multicolor LED source for emitting a first light beam in a first direction;
a white light source arranged and implemented separately from the multicolor LED source in order to emit a second light beam in a second direction;
a projection optics for outputting an output light beam of the light; and
an optical element which is implemented to be capable of being brought into at least two different states so that in a first state the output light beam is mainly formed by the first light beam and that in a second state the output light beam is mainly formed by the second light beam.

2. The light according to claim 1, wherein the optical element is a movable optical element and wherein the two states are different positions.

3. The light according to claim 1, wherein the multicolor LED source comprises three LED chips which are implemented to emit at three different colors.

4. The light according to claim 1, wherein the white light source comprises an LED chip comprising a conversion layer.

5. The light according to claim 1, wherein the optical element is a tilting mirror which is implemented not to be arranged in an optical path of the multicolor LED source in a first position and which is further implemented to be arranged in the optical path of the multicolor LED source in a second position to reflect the first light beam away from the projection optics and to redirect the second light beam towards the projection optics.

6. The light according to claim 1, wherein the optical element comprises a dichroic filter which is implemented to transmit a defined emission band of the multicolor LED source and to reflect light comprising wavelengths outside this band.

7. The light according to claim 6, wherein the defined emission band comprises wavelengths for red light such that the output light beam is a mixture of the second light beam and a red portion of the first light beam when the optical element is in the second state.

8. The light according to claim 1, wherein the multicolor LED source comprises an LED controller for independently controlling emission intensities of the LED elements of different colors in the multicolor LED source.

9. The light according to claim 1, wherein the optical element comprises a rotatable element comprising areas of different nature, wherein the rotatable element is implemented so that a first area lets the first light beam or the second light beam pass to the projection optics and that in the second position a different one of the two light beams is directed towards the projection optics by the second area.

10. The light according to claim 9, wherein the first area is a recess and the second area is a mirror surface or a dichroic filter.

11. The light according to claim 1, wherein the second direction of the second light beam is basically orthogonal to the first direction of the first light beam and the optical element in the second state is basically arranged in a 45° angle to the first and to the second direction.

12. The light according to claim 9, wherein the rotatable element is a wheel and the areas of different nature comprise sectors of the wheel of a different size.

13. The light according to claim 9, wherein the rotatable element comprises a first disc comprising areas of different nature and a second disc comprising areas of different nature, wherein further a motor exists for moving the first and second discs relative to each other and wherein the motor is further implemented to rotate the two discs in a fixed position with respect to each other.

14. The light according to claim 9, further comprising:
a controller for controlling the multicolor LED source by PWM signals and for controlling the motor, wherein the controller is implemented to synchronize the rotation of the rotatable element with the PWM signals.

15. The light according to claim 1,
wherein the multicolor LED source comprises an LED for red light, an LED for green light and an LED for blue light;
wherein the white light source comprises an LED for white light with a first color temperature;
wherein the optical element comprises a dichroic filter for letting red light pass, and
wherein the optical element and the multicolor LED source are implemented so that the output light beam comprises a second color temperature which is lower than the first color temperature.

16. The light according to claim 1,
wherein the multicolor LED source comprises three LED circuits which are arranged orthogonal to each other, wherein further two filters are arranged crosswise and twisted with respect to the arrangement of the LED circuits to generate a mixed output light beam.

17. A method for operating a light comprising a multicolor LED source for emitting a first light beam in a first direction, a white light source arranged separately from the multicolor LED source and implemented to emit a second light beam in a second direction; a projection optics for outputting the output light beam of the light and an optical element which is implemented to be capable of being brought into at least two different states, comprising:
bringing the optical element into the first state so that the output light beam is mainly formed by the first light beam; and
bringing the optical element into the second state so that the output light beam is mainly formed by the second light beam.
